(19) United States
(12) Patent Application Publication
(10) Pub. No.: US 2010/0247185 A1
(43) Pub. Date: Sep. 30, 2010

(54) FIXING DEVICE AND IMAGE FORMING APPARATUS

(76) Inventors: Motofumi Baba, Ebina-shi (JP); Yasutaka Naito, Ebina-shi (JP); Shigehiko Haseba, Ebina-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/568,186

(22) Filed: Sep. 28, 2009

(30) Foreign Application Priority Data
Mar. 27, 2009 (JP) 2009-080521

(51) Int. Cl. G03G 15/20

(52) U.S. Cl. 399/329

(57) ABSTRACT

The fixing device includes: a fixing member including a conductive layer, and fixing toner on a recording medium by heat generation of the conductive layer by electromagnetic induction; a magnetic field generating member generating an alternate-current magnetic field intersecting with the conductive layer; and a magnetic path forming member that has an outer circumferential surface arranged to be in contact with an inner circumferential surface of the fixing member, that forms a magnetic path of the alternate-current magnetic field generated by the magnetic field generating member, and that includes: a magnetic layer having a changing range within a temperature range of about 20 degrees C., the changing range allowing a magnetic property of the magnetic layer to change between ferromagnetic and a paramagnetic properties in accordance with temperature; and an outer circumferential layer made of any one of or both chromium nitride as CrN and chromium nitride as Cr₂N.

### CROSS REFERENCE TO RELATED APPLICATIONS

This application is based on and claims priority under 35 USC §119 from Japanese Patent Application No. 2009-080521 filed Mar. 27, 2009.

### BACKGROUND

1. Technical Field

The present invention relates to a fixing device and an image forming apparatus.

2. Related Art

Fixing devices using an electromagnetic induction heating method are known as the fixing devices each to be installed in an image forming apparatus such as a copy machine and a printer using an electrophotographic method.

### SUMMARY

According to an aspect of the present invention, there is provided a fixing device including: a fixing member that includes a conductive layer, and fixes toner on a recording medium by heat generation of the conductive layer by electromagnetic induction; a magnetic field generating member that generates an alternate-current magnetic field intersecting with the conductive layer of the fixing member; and a magnetic path forming member that has an outer circumferential surface arranged to be in contact with an inner circumferential surface of the fixing member, that forms a magnetic path of the alternate-current magnetic field generated by the magnetic field generating member, and that includes: a magnetic layer configured to have a changing range within a temperature range of about 20 degrees C., the changing range allowing a magnetic property of the magnetic layer to change between a ferromagnetic property and a paramagnetic property in accordance with temperature; and an outer circumferential layer made of any one of or both chromium nitride represented by a chemical formula of CrN and chromium nitride represented by a chemical formula of Cr₂N.

### BRIEF DESCRIPTION OF THE DRAWINGS

Exemplary embodiments of the present invention will be described in detail based on the following figures, wherein:

FIG. 1 is a diagram showing a configuration example of an image forming apparatus to which a fixing device of the exemplary embodiment is applied;

FIG. 2 is a front view of the fixing unit of the exemplary embodiment;

FIG. 3 is a cross sectional view of the fixing unit, taken along the line III-III in FIG. 2;

FIG. 4 is a configuration diagram showing cross sectional layers of the fixing belt;

FIG. 5A is a side view of one of the end caps, and FIG. 5B is a plain view of the end cap when viewed from a VB direction of FIG. 5A;

FIG. 6 is a cross sectional view for explaining a configuration of the IH heater;

FIG. 7 is a diagram for explaining the state of the magnetic field lines in a case where the temperature of the fixing belt is within a temperature range not greater than the permeability change start temperature;

FIG. 8 is a diagram showing a summary of a temperature distribution in the width direction of the fixing belt when the small size sheets are successively inserted into the fixing unit;

FIG. 9 is a diagram for explaining a state of the magnetic field lines when the temperature of the fixing belt at the non-sheet passing regions is within a temperature range exceeding the permeability change start temperature;

FIG. 10 is a graph showing an example of the temperature characteristics of the relative permeability of the temperature-sensitive magnetic member; and

FIG. 11 is a configuration diagram showing a cross sectional layers of the temperature-sensitive magnetic member.

### DETAILED DESCRIPTION

An exemplary embodiment of the present invention will be described below in detail with reference to the accompanying drawings.

### <Description of Image Forming Apparatus>

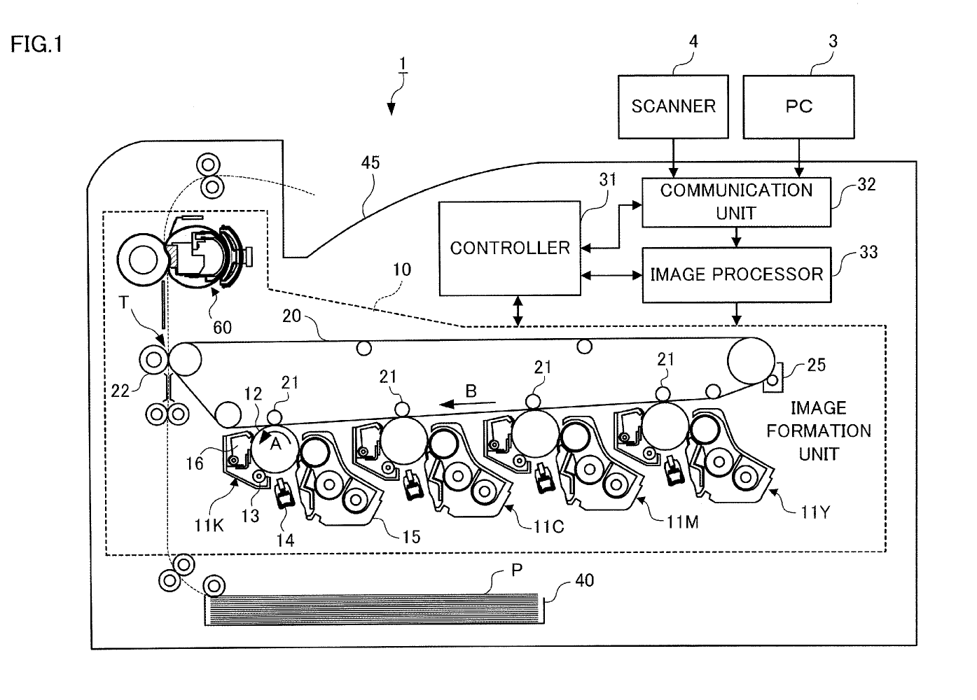

FIG. 1 is a diagram showing a configuration example of an image forming apparatus to which a fixing device of the exemplary embodiment is applied. An image forming apparatus 1 shown in FIG. 1 is a so-called tandem-type color printer, and includes: an image formation unit 10 that performs image formation on the basis of image data; and a controller 31 that controls operations of the entire image forming apparatus 1. The image forming apparatus 1 further includes: a communication unit 32 that communicates with, for example, a personal computer (PC) 3, an image reading apparatus (scanner) 4 or the like to receive image data; and an image processor 33 that performs image processing set in advance on image data received by the communication unit 32.

The image formation unit 10 includes four image forming units 11Y, 11M, 11C and 11K (also collectively referred to as an “image forming unit 11”) as examples of a toner image forming unit, which are arranged side by side at certain intervals. Each of the image forming units 11 includes: a photoconductive drum 12 as an example of an image carrier that forms an electrostatic latent image and holds a toner image; a charging device 13 that uniformly charges the surface of the photoconductive drum 12 at a potential set in advance; a light emitting diode (LED) print head 14 that exposes, on the basis of color image data, the photoconductive drum 12 charged by the charging device 13; a developing device 15 that develops the electrostatic latent image formed on the photoconductive drum 12; and a cleaner 16 that cleans the surface of the photoconductive drum 12 after transfer.

The image forming units 11 have almost the same configuration except toner contained in the developing device 15, and form yellow (Y), magenta (M), cyan (C) and black (K) color toner images, respectively.

Further, the image formation unit 10 includes: an intermediate transfer belt 20 onto which multiple layers of color toner images formed on the photoconductive drums 12 of the image forming units 11 are transferred; and primary transfer rolls 21 that sequentially transfer (primarily transfer) color toner images formed in respective image forming units 11 onto the intermediate transfer belt 20. Furthermore, the image formation unit 10 includes: a secondary transfer roll 22 that collectively transfers (secondarily transfers) the color toner images superimposingly transferred onto the intermediate transfer belt 20 onto a sheet P which is a recording medium (recording sheet); and a fixing unit 60 as an example of a fixing unit (a fixing device) that fixes the color toner images having been secondarily transferred, onto the sheet P. Note that, in the image forming apparatus 1 according to the present exemplary embodiment, the intermediate transfer belt 20, the primary transfer rolls 21 and the secondary transfer roll 22 configure a transfer unit.

In the image forming apparatus 1 of the present exemplary embodiment, image formation processing using the following processes is performed under operations controlled by the controller 31. Specifically, image data from the PC 3 or the scanner 4 is received by the communication unit 32, and after the image data is subjected to predetermined image processing performed by the image processor 33, the image data of each color is generated and sent to a corresponding one of the image forming units 11. Then, in the image forming unit 11K that forms a black-color (K) toner image, for example, the photoconductive drum 12 is uniformly charged by the charging device 13 at the potential set in advance while rotating in a direction of an arrow A, and then is exposed by the LED print head 14 on the basis of the black color image data transmitted from the image processor 33. Thereby, an electrostatic latent image for the black-color image is formed on the photoconductive drum 12. The black-color electrostatic latent image formed on the photoconductive drum 12 is then developed by the developing device 15. Then, the black-color toner image is formed on the photoconductive drum 12. In the same manner, yellow (Y), magenta (M) and cyan (C) color toner images are formed in the image forming units 11Y, 11M and 11C, respectively.

The color toner images formed on the respective photoconductive drums 12 in the image forming units 11 are electrostatically transferred (primarily transferred), in sequence, onto the intermediate transfer belt 20 that moves in a direction of an arrow B, by the primary transfer rolls 21. Then, superimposed toner images on which the color toner images are superimposed on one another are formed. Then, the superimposed toner images on the intermediate transfer belt 20 are transported to a region (secondary transfer portion T) at which the secondary transfer roll 22 is arranged, along with the movement of the intermediate transfer belt 20. The sheet P is supplied from a sheet holding unit 40 to the secondary transfer portion T at a timing when the superimposed toner images being transported arrive at the secondary transfer portion T. Then, the superimposed toner images are collectively and electrostatically transferred (secondarily transferred) onto the transported sheet P by action of a transfer electric field formed at the secondary transfer portion T by the secondary transfer roll 22.

Thereafter, the sheet P onto which the superimposed toner images are electrostatically transferred is transported toward the fixing unit 60. The toner images on the sheet P transported to the fixing unit 60 are heated and pressurized by the fixing unit 60 and thereby are fixed onto the sheet P. Then, the sheet P including the fixed images formed thereon is transported to a sheet output unit 45 provided at an output portion of the image forming apparatus 1.

Meanwhile, the toner (primary-transfer residual toner) attached to the photoconductive drums 12 after the primary transfer and the toner (secondary-transfer residual toner) attached to the intermediate transfer belt 20 after the secondary transfer are removed by the cleaners 16 and a belt cleaner 25, respectively.

In this way, the image formation processing in the image forming apparatus 1 is repeatedly performed for a designated number of print sheets.

### <Description of Configuration of Fixing Unit>

Next, a description will be given of the fixing unit 60 in the present exemplary embodiment.

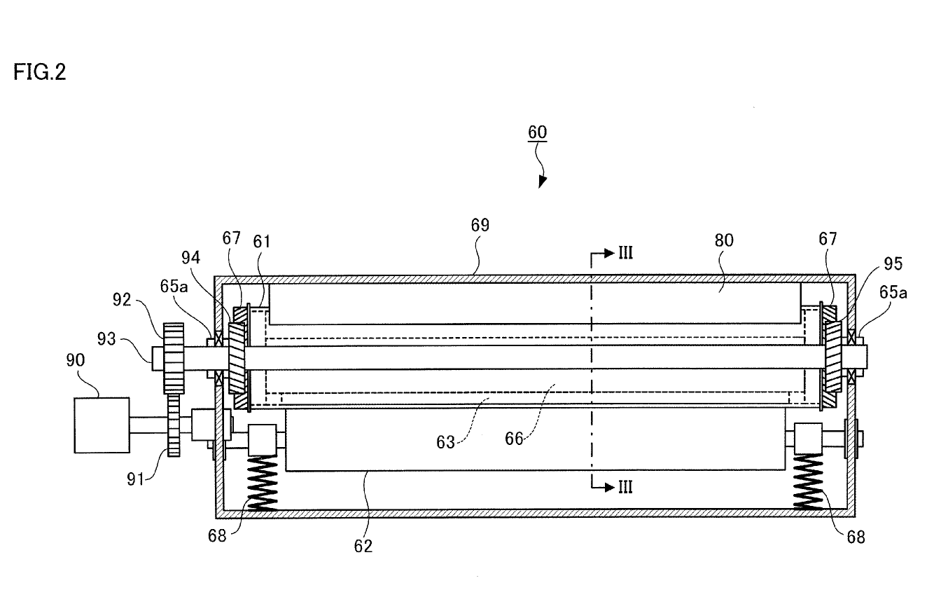

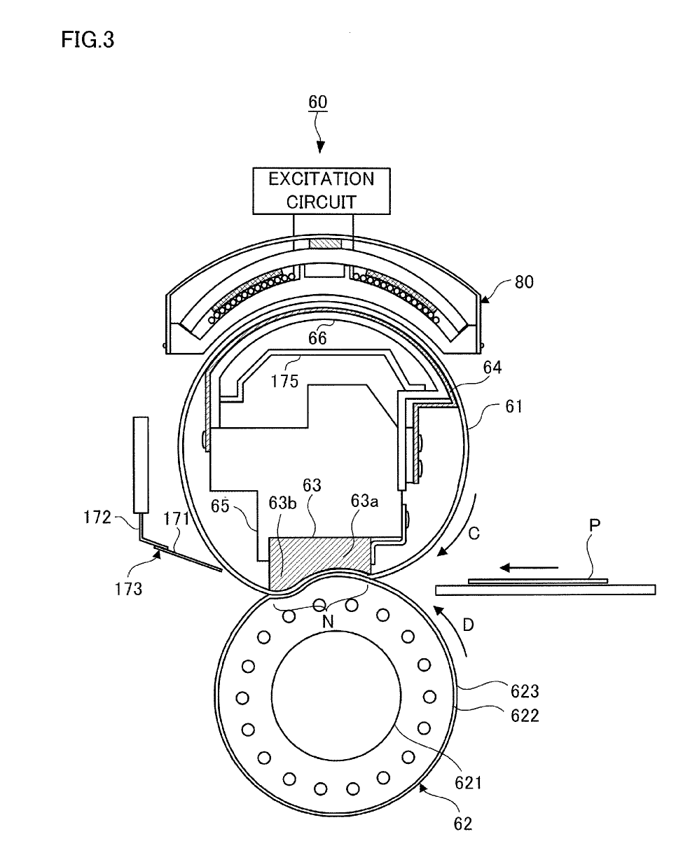

FIGS. 2 and 3 are diagrams showing a configuration of the fixing unit 60 of the exemplary embodiment. FIG. 2 is a front view of the fixing unit 60, and FIG. 3 is a cross sectional view of the fixing unit 60, taken along the line III-III in FIG. 2.

Firstly, as shown in FIG. 3, which is a cross sectional view, the fixing unit 60 includes: an induction heating (IH) heater 80 as an example of a magnetic field generating member that generates an AC (alternate-current) magnetic field; a fixing belt 61 as an example of a fixing member that is subjected to electromagnetic induction heating by the IH heater 80, and thereby fixes a toner image; a pressure roll 62 that is arranged in a manner to face the fixing belt 61; and a pressing pad 63 that is pressed by the pressure roll 62 with the fixing belt 61 therebetween.

The fixing unit 60 further includes: a holder 65 that supports a constituent member such as the pressing pad 63 and the like; a temperature-sensitive magnetic member 64 as an example of a magnetic path forming member that forms a magnetic path by inducing the AC magnetic field generated at the IH heater 80; an induction member 66 that induces magnetic field lines passing through the temperature-sensitive magnetic member 64; a magnetic path shielding member 175 that prevents the magnetic path from leaking toward the holder 65; and a peeling assisting member 173 that assists peeling of the sheet P from the fixing belt 61.

### <Description of Fixing Belt>

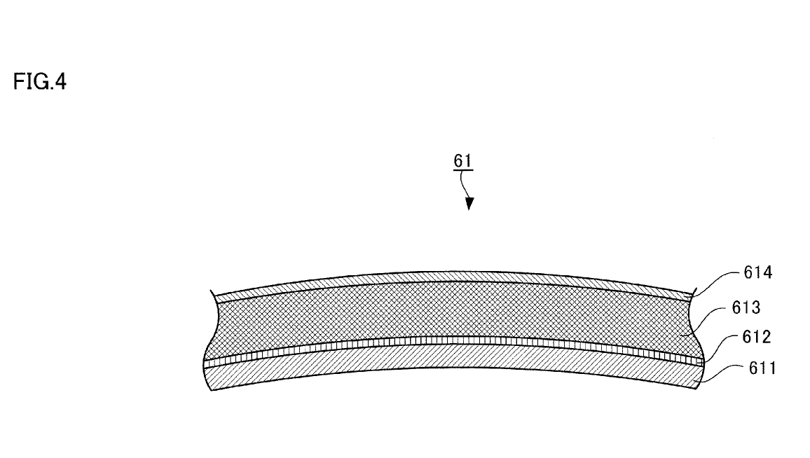

The fixing belt 61 is formed of an endless belt member originally formed into a cylindrical shape, and is formed with a diameter of 30 mm and a width-direction length of 370 mm in the original shape (cylindrical shape), for example. In addition, as shown in FIG. 4 (a configuration diagram showing cross sectional layers of the fixing belt 61), the fixing belt 61 is a belt member having a multi-layer structure including: a base layer 611; a conductive heat-generating layer 612 that is coated on the base layer 611; an elastic layer 613 that improves fixing properties of a toner image; and a surface release layer 614 that is applied as the uppermost layer.

The base layer 611 is formed of a heat-resistant sheet-like member that supports the conductive heat-generating layer 612, which is a thin layer, and that gives a mechanical strength to the entire fixing belt 61. Moreover, the base layer 611 is formed of a certain material with a certain thickness. The material has properties (relative permeability, specific resistance) that allow a magnetic field to pass therethrough so that the AC magnetic field generated at the IH heater 80 may act on the temperature-sensitive magnetic member 64. Meanwhile, the base layer 611 itself is formed so as not to generate heat by action of the magnetic field or not to easily generate heat.

Specifically, for example, a non-magnetic metal such as a non-magnetic stainless steel having a thickness of 30 to 200 μm (preferably, 50 to 150 μm), or a resin material or the like having a thickness of 60 to 200 μm is used as the base layer 611.

The conductive heat-generating layer 612 is an example of a conductive layer and is an electromagnetic induction heat-generating layer that generates heat by electromagnetic induction of the AC magnetic field generated at the IH heater 80. Specifically, the conductive heat-generating layer 612 is a layer that generates an eddy current when the AC magnetic field from the IH heater 80 passes therethrough in the thickness direction.

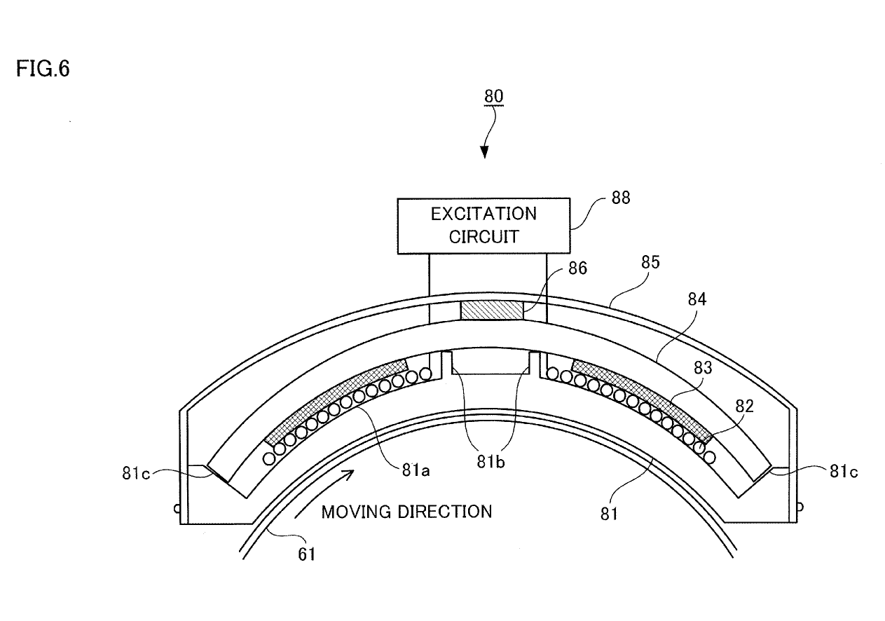

Normally, an inexpensively manufacturable general-purpose power supply is used as the power supply for an excitation circuit 88 that supplies an AC current to the IH heater 80 (also refer to later described FIG. 6). For this reason, in general, a frequency of the AC magnetic field generated by the IH heater 80 ranges from 20 kHz to 100 kHz by use of the general-purpose power supply. Accordingly, the conductive heat-generating layer 612 is formed to allow the AC magnetic field having a frequency of 20 kHz to 100 kHz to enter and to pass therethrough.

A region of the conductive heat-generating layer 612, where the AC magnetic field is allowed to enter is defined as a “skin depth δ” representing a region where the AC magnetic field attenuates to 1/e. The skin depth δ is calculated by use of the following formula (1), where f is a frequency of the AC magnetic field (20 kHz, for example), ρ is a specific resistance value (Ω·m), and μᵣ is a relative permeability.

Accordingly, in order to allow the AC magnetic field having a frequency of 20 kHz to 100 kHz to enter and then to pass through the conductive heat-generating layer 612, the thickness of the conductive heat-generating layer 612 is formed to be smaller than the skin depth δ of the conductive heat-generating layer 612, which is defined by the formula (1). In addition, as the material that forms the conductive heat-generating layer 612, a metal such as Au, Ag, Al, Cu, Zn, Sn, Pb, Bi, Be or Sb, or a metal alloy including at least one of these elements is used, for example.

$$δ = 503 \sqrt{\frac{ρ}{f \cdot {μ}_{r}}} \qquad ( 1 )$$

Specifically, as the conductive heat-generating layer 612, a non-magnetic metal (having a relative permeability substantially equal to 1) including Cu or the like, having a thickness of 2 to 20 μm and a specific resistance value not greater than 2.7×10⁻⁸ Ω·m is used, for example.

In addition, in view of shortening the period of time required for heating the fixing belt 61 to reach a fixation setting temperature (hereinafter, referred to as a “warm-up time”) as well, the conductive heat-generating layer 612 may be formed of a thin layer.

Next, the elastic layer 613 is formed of a heat-resistant elastic material such as a silicone rubber. The toner image to be held on the sheet P, which is to become the fixation target, is formed of a multi-layer of color toner as powder. For this reason, in order to uniformly supply heat to the entire toner image at a nip portion N, the surface of the fixing belt 61 may particularly be deformed so as to correspond with unevenness of the toner image on the sheet P. In this respect, a silicone rubber having a thickness of 100 to 600 μm and a hardness of 10° to 30° (JIS-A), for example, may be used for the elastic layer 613.

The surface release layer 614 directly contacts with an unfixed toner image held on the sheet P. Accordingly, a material with a high releasing property is used. For example, a PFA (a copolymer of tetrafluoroethylene and perfluoroalkylvinylether) layer, a PTFE (polytetrafluoroethylene) layer or a silicone copolymer layer or a composite layer formed of these layers is used. As to the thickness of the surface release layer 614, if the thickness is too small, no sufficient abrasion resistance is obtained, hence, reducing the life of the fixing belt 61. On the other hand, if the thickness is too large, the heat capacity of the fixing belt 61 becomes so large that the warm-up time becomes longer. In this respect, the thickness of the surface release layer 614 may be particularly 1 to 50 μm in consideration of the balance between the abrasion resistance and heat capacity.

### <Description of Pressing Pad>

The pressing pad 63 is formed of an elastic material such as a silicone rubber or fluorine rubber, and is supported by the holder 65 at a position facing the pressure roll 62. Then, the pressing pad 63 is arranged in a state of being pressed by the pressure roll 62 with the fixing belt 61 therebetween, and forms the nip portion N with the pressure roll 62.

In addition, the pressing pad 63 has different nip pressures set for a pre-nip region 63a on the sheet entering side of the nip portion N (upstream side in the transport direction of the sheet P) and a peeling nip region 63b on the sheet exit side of the nip portion N (downstream side in the transport direction of the sheet P), respectively. Specifically, a surface of the pre-nip region 63a at the pressure roll 62 side is formed into a circular arc shape approximately corresponding with the outer circumferential surface of the pressure roll 62, and the nip portion N, which is uniform and wide, is formed. Moreover, a surface of the peeling nip region 63b at the pressure roll 62 side is formed into a shape so as to be locally pressed with a larger nip pressure from the surface of the pressure roll 62 in order that a curvature radius of the fixing belt 61 passing through the peeling nip region 63b may be small. Thereby, a curl (down curl) in a direction in which the sheet P is separated from the surface of the fixing belt 61 is formed on the sheet P passing through the peeling nip region 63b, thereby promoting the peeling of the sheet P from the surface of the fixing belt 61.

Note that, in the present exemplary embodiment, the peeling assisting member 173 is arranged at the downstream side of the nip portion N as an assistance unit for the peeling of the sheet P by the pressing pad 63. In the peeling assisting member 173, a peeling baffle 171 is supported by a holder 172 in a state of being positioned to be close to the fixing belt 61 in a direction opposite to the rotational moving direction of the fixing belt 61 (so-called counter direction). Then, the peeling baffle 171 supports the curl portion formed on the sheet P at the exit of the pressing pad 63, thereby preventing the sheet P from moving toward the fixing belt 61.

### <Description of Temperature-Sensitive Magnetic Member>

Next, the temperature-sensitive magnetic member 64 is formed into a circular arc shape corresponding with an inner circumferential surface of the fixing belt 61 and is arranged to be in contact with the inner circumferential surface of the fixing belt 61. Thereby, the temperature of the temperature-sensitive magnetic member 64 changes in accordance with the temperature of the fixing belt 61, and the temperature-sensitive magnetic member 64 functions as a detector that detects temperature of the fixing belt 61.

Moreover, the temperature-sensitive magnetic member 64 is formed of a material whose “permeability change start temperature” at which the permeability of the magnetic properties drastically changes is not less than the fixation setting temperature at which each color toner image starts melting, and whose permeability change start temperature is also set within a temperature range lower than the heat-resistant temperatures of the elastic layer 613 and the surface release layer 614 of the fixing belt 61. Specifically, the temperature-sensitive magnetic member 64 is formed of a material having a property (“temperature-sensitive magnetic property”) that reversibly changes between the ferromagnetic property and the non-magnetic property (paramagnetic property) in a temperature range including the fixation setting temperature. Thus, the temperature-sensitive magnetic member 64 functions as a magnetic path forming member within a temperature range not greater than the permeability change start temperature, where the temperature-sensitive magnetic member 64 has the ferromagnetic property. The temperature-sensitive magnetic member 64 induces magnetic field lines generated by the IH heater 80 and going through the fixing belt 61 to the inside thereof, and forms a magnetic path so that the magnetic field lines may pass through the inside of the temperature-sensitive magnetic member 64. Thereby, the temperature-sensitive magnetic member 64 forms a closed magnetic path that internally wraps the fixing belt 61 and an excitation coil 82 (refer to later-described FIG. 6) of the IH heater 80. Meanwhile, within a temperature range exceeding the permeability change start temperature, the temperature-sensitive magnetic member 64 causes the magnetic field lines generated by the IH heater 80 and going through the fixing belt 61 to go therethrough so as to run across the temperature-sensitive magnetic member 64 in the thickness direction of the temperature-sensitive magnetic member 64. Then, the magnetic field lines generated by the IH heater 80 and going through the fixing belt 61 form a magnetic path in which the magnetic field lines go through the temperature-sensitive magnetic member 64, and then pass through the inside of the induction member 66 and return to the IH heater 80.

Examples of the material of the temperature-sensitive magnetic member 64 include a binary temperature-sensitive magnetic alloy such as a Fe—Ni alloy (permalloy) or a ternary temperature-sensitive magnetic alloy such as a Fe—Ni—Cr alloy whose permeability change start temperature used as the fixation setting temperature is set within a range of, for example, 140 degrees C. to 240 degrees C. For example, the permeability change start temperature may be set around a range from 220 degrees C. to 225 degrees C. by setting the ratios of Fe and Ni at approximately 64% and 36% (atom number ratio), respectively, in a binary temperature-sensitive magnetic alloy of Fe—Ni. The aforementioned metal alloys or the like including the permalloy and the temperature-sensitive magnetic alloy are suitable for the temperature-sensitive magnetic member 64 since they are excellent in molding property and processability, and a high heat conductivity as well as less expensive costs. Another example of the material includes a metal alloy made of Fe, Ni, Si, B, Nb, Cu, Zr, Co, Cr, V, Mn, Mo or the like.

In addition, the temperature-sensitive magnetic member 64 is formed with a thickness larger than the skin depth δ (refer to the formula (1) described above) with respect to the AC magnetic field (magnetic field lines) generated by the IH heater 80. Specifically, a thickness of approximately 50 to 300 μm is set when a Fe—Ni alloy is used as the material, for example.

Moreover, the temperature-sensitive magnetic member according to the present exemplary embodiment also functions as a heater, and supplies heat to the fixing belt 61, which is arranged to be in contact with the temperature-sensitive magnetic member 64. In this way, the temperature-sensitive magnetic member 64 assists the fixing belt 61 to generate heat, the fixing belt 61 functioning as the fixing member that fixes toner images. Thereby, the temperature of the fixing belt 61 is kept within a range around the fixation setting temperature at the time of image formation. Thus, the temperature-sensitive magnetic member 64 itself generates heat and then supplies the heat to the fixing belt 61. This, for example, enables a configuration for suppressing a temporary drop in the temperature (so-called temperature droop phenomenon) of the fixing belt 61 and the like, likely to occur at the time when the fixing belt 61 starts performing fixing operation, and for thereby stably keeping the temperature of the fixing belt 61 within a range around the fixation setting temperature.

### <Description of Holder>

The holder 65 that supports the pressing pad 63 is formed of a material having a high rigidity so that the amount of deflection in a state where the pressing pad 63 receives pressing force from the pressure roll 62 may be a certain amount or less. In this manner, the amount of pressure (nip pressure N) at the nip portion N in the longitudinal direction is kept uniform. Moreover, since the fixing unit 60 of the present exemplary embodiment employs a configuration in which the fixing belt 61 generates heat by use of electromagnetic induction, the holder 65 is formed of a material that provides no influence or hardly provides influence to an induction magnetic field, and that is not influenced or is hardly influenced by the induction magnetic field. For example, a heat-resistant resin such as glass mixed PPS (polyphenylene sulfide), or a non-magnetic metal material such as Al, Cu or Ag is used.

### <Description of Induction Member>

The induction member 66 is formed into a circular arc shape corresponding with the inner circumferential surface of the temperature-sensitive magnetic member 64 and is arranged to be in contact with the inner circumferential surface of the temperature-sensitive magnetic member 64. The induction member 66 is formed of, for example, a non-magnetic metal such as Ag, Cu and Al having a relatively small specific resistance. When the temperature of temperature-sensitive magnetic member 64 increases to a temperature not less than the permeability change start temperature, the induction member 66 induces an AC magnetic field (magnetic field lines) generated by the IH heater 80 and thereby forms a state where an eddy current I is more easily generated in comparison with the conductive heat generating layer 612 of the fixing belt 61. For this reason, the thickness of the induction member 66 is formed to be a thickness (1.0 mm, for example) sufficiently larger than the skin depth δ (refer to the aforementioned formula (1)) so as to allow the eddy current I to easily flow therethrough.

Moreover, the induction member 66 also functions as a heat storage body for heat generated at the temperature-sensitive magnetic member 64. The induction member 66 is arranged to be in contact with the temperature-sensitive magnetic member 64, and thereby stores heat generated at the temperature-sensitive magnetic member 64. The induction member 66 supplies heat to the fixing belt 61 through the temperature-sensitive magnetic member 64, thereby keeping the temperature of the fixing belt 61 within a range around the fixation setting temperature at the time of image formation. Specifically, the induction member 66 of the present exemplary embodiment stores heat generated at the temperature-sensitive magnetic member 64, and supplies the heat to the fixing belt 61 through the temperature-sensitive magnetic member 64 when the temperature of the fixing belt 61 drops. Thus, the induction member 66 functions to assist the temperature-sensitive magnetic member 64 to suppress a temporary drop in the temperature (temperature droop phenomenon) of the fixing belt 61, likely to occur at the time when the fixing belt 61 starts performing fixing operation, and functions to thereby stably keep the temperature of the fixing belt 61 within a range around the fixation setting temperature.

### <Description of Drive Mechanism of Fixing Belt>

Next, a description will be given of a drive mechanism of the fixing belt 61.

As shown in FIG. 2, which is a front view, end caps 67 are secured to both ends in the axis direction of the holder (refer to FIG. 3), respectively. The end caps 67 rotationally drive the fixing belt 61 in a circumferential direction while keeping cross sectional shapes of both ends of the fixing belt 61 in a circular shape. Then, the fixing belt 61 directly receives rotational drive force via the end caps 67 at the both ends and rotationally moves at, for example, a process speed of about 140 mm/s in a direction of an arrow C in FIG. 3.

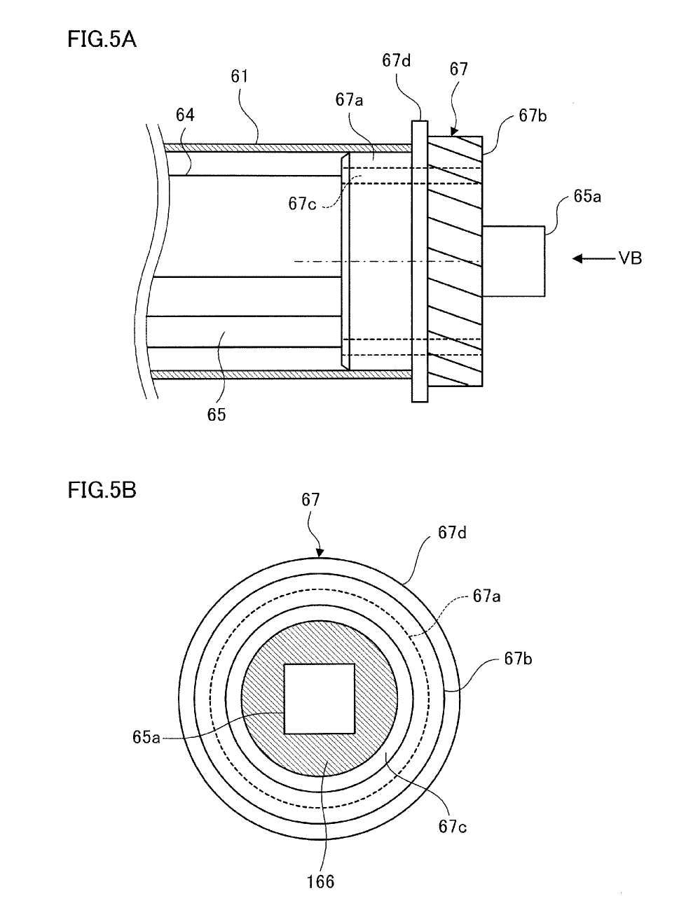

Here, FIG. 5A is a side view of one of the end caps 67, and FIG. 5B is a plain view of the end cap 67 when viewed from a VB direction of FIG. 5A. As shown in FIGS. 5A and 5B, the end cap 67 includes: a fixing unit 67a that is fitted into the inside of a corresponding one of the ends of the fixing belt 61; a flange 67d that is formed so as to project from the fixing belt 61 in the radial direction when attached to the fixing belt 61; a gear 67b to which the rotational drive force is transmitted; and a bearing unit 67c that is rotatably connected to a support member 65a formed at a corresponding one of the ends of the holder 65 with a connection member 166 interposed therebetween. Then, as shown in FIG. 2, the support members 65a at the both ends of the holder 65 are secured onto the both ends of a chassis 69 of the fixing unit 60, respectively, thereby, supporting the end caps 67 so as to be rotatable with the bearing units 67c respectively connected to the support members 65a.

As the material of the end caps 67, so called engineering plastics having a high mechanical strength or heat-resistant properties is used. For example, a phenol resin, polyimide resin, polyamide resin, polyamide-imide resin, PEEK resin, PES resin, PPS resin, LCP resin or the like is suitable.

Then, as shown in FIG. 2, in the fixing unit 60, rotational drive force from a drive motor 90 is transmitted to a shaft 93 via transmission gears 91 and 92. The rotational drive force is then transmitted from transmission gears 94 and 95 connected to the shaft 93 to the gears 67b of the respective end caps 67 (refer to FIGS. 5A and 5B). Thereby, the rotational drive force is transmitted from the end caps 67 to the fixing belt 61, and the end caps 67 and the fixing belt 61 are integrally driven to rotate.

As described above, the fixing belt 61 directly receives the drive force at the both ends of the fixing belt 61 to rotate, thereby rotating stably.

Here, a torque of approximately 0.1 to 0.5 N·m is generally exerted when the fixing belt 61 directly receives the drive force from the end caps 67 at the both ends thereof and then rotates. However, in the fixing belt 61 of the present exemplary embodiment, the base layer 611 is formed of, for example, a non-magnetic stainless steel having a high mechanical strength. Thus, buckling or the like does not easily occur on the fixing belt 61 even when a torsional torque of approximately 0.1 to 0.5 N·m is exerted on the entire fixing belt 61.

In addition, the fixing belt 61 is prevented from inclining or leaning to one direction by the flanges 67d of the end caps 67, but at this time, compressive force of approximately 1 to 5 N is exerted toward the axis direction from the ends (flanges 67d) on the fixing belt 61 in general. However, even in a case where the fixing belt 61 receives such compressive force, the occurrence of buckling or the like is prevented since the base layer 611 of the fixing belt 61 is formed of a non-magnetic stainless steel or the like.

As described above, the fixing belt 61 of the present exemplary embodiment receives the drive force directly at the both ends of the fixing belt 61 to rotate, thereby, rotating stably. In addition, the base layer 611 of the fixing belt 61 is formed of, for example, a non-magnetic stainless steel or the like having a high mechanical strength, hence providing the configuration in which buckling or the like caused by a torsion torque or compressive force does not easily occur in this case. Moreover, the softness and flexibility of the entire fixing belt 61 is obtained by forming the base layer 611 and the conductive heat-generating layer 612 respectively as thin layers, so that the fixing belt 61 is deformed so as to correspond with the nip portion N and recovers to the original shape.

With reference back to FIG. 3, the pressure roll 62 is arranged to face the fixing belt 61 and rotates at, for example, a process speed of 140 mm/s in the direction of an arrow D in FIG. 3 while being driven by the fixing belt 61. Then, the nip portion N is formed in a state where the fixing belt 61 is held between the pressure roll 62 and the pressing pad 63. Then, while the sheet P holding an unfixed toner image is caused to pass through this nip portion N, heat and pressure are applied to the sheet P, and thereby, the unfixed toner image is fixed onto the sheet P.

The pressure roll 62 is formed of a multi-layer including: a solid aluminum core (cylindrical core metal) 621 having a diameter of 18 mm, for example; a heat-resistant elastic layer 622 that covers the outer circumferential surface of the core 621, and that is made of silicone sponge having a thickness of 5 mm, for example; and a release layer 623 that is formed of a heat-resistant resin such as PFA containing carbon or the like, or a heat-resistant rubber, having a thickness of 50 μm, for example, and that covers the heat-resistant elastic layer 622. Then, the pressing pad 63 is pressed under a load of 25 kgf for example, by pressing springs 68 (refer to FIG. 2) with the fixing belt 61 therebetween.

### <Description of IH Heater>

Next, a description will be given of the IH heater 80 that induces the heat generation of the fixing belt 61 by electromagnetic induction with an action of an AC magnetic field in the conductive heat-generating layer 612 of the fixing belt 61.

FIG. 6 is a cross sectional view for explaining a configuration of the IH heater 80 of the exemplary embodiment. As shown in FIG. 6, the IH heater 80 includes: a support member 81 that is formed of a non-magnetic material such as a heat-resistant resin, for example; and the excitation coil 82 that generates the AC magnetic field. Moreover, the IH heater 80 includes: elastic support members 83 each of which is formed of an elastic material and secures the excitation coil 82 onto the support member 81; and a magnetic core 84 that forms a magnetic path of the AC magnetic field generated by the excitation coil 82. Further, the IH heater 80 includes: a shield 85 that shields a magnetic field; a pressing member 86 that presses the magnetic cores 84 toward the support member 81; and the excitation circuit 88 that supplies an AC current to the excitation coil 82.

The support member 81 is formed to have a cross section in a shape curving along the surface shape of the fixing belt 61, includes an upper surface (supporting surface) 81a that supports the excitation coils 82, and is formed and set so as to keep a gap set in advance (for example, 0.5 to 2 mm) with a surface of the fixing belt 61. The support member 81 also includes: a pair of magnetic core supporting units 81b arranged in parallel in a longitudinal direction at a center, in a moving direction of the fixing belt 61, of the supporting surface 81a; and magnetic core regulators 81c that restrict the arrangement position of the magnetic core 84 in the moving direction of the fixing belt 61 at both end portions, in the moving direction of the fixing belt 61, of the supporting surface 81a. The pair of magnetic core supporting units 81b support the magnetic core 84 between the magnetic core regulators 81c provided at the both end portions of the supporting surface 81a, in such a way that the magnetic core 84 is movable back and forth in the moving direction of the fixing belt 61. This enables the support member 81 to support the magnetic core 84 so that the gaps between the magnetic core 84 and the supporting surface 81a respectively at an upstream region and a downstream region would position approximately symmetric with respect to the central portion in the moving direction of the fixing belt 61, the gap being likely to vary in shape due to heat treatment applied at the time of manufacture.

As a material of the support member 81, a non-magnetic material having heat resistance is used, such as heat-resistant glass; heat-resistant resin such as polycarbonate, polyether sulphone and polyphenylene sulfide (PPS); and the aforementioned heat-resistant resin mixed with glass fibers.

The excitation coil 82 is formed by winding a litz wire in a closed loop of an oval shape, elliptical shape or rectangular shape having an opening inside, the litz wire being obtained by bundling 90 pieces of mutually insulated copper wires each having a diameter of 0.17 mm, for example. Then, when an AC current having a frequency set in advance is supplied from the excitation circuit 88 to the excitation coil 82, an AC magnetic field on the litz wire wound in a closed loop shape as the center is generated around the excitation coil 82. In general, a frequency of 20 kHz to 100 kHz, which is generated by the aforementioned general-purpose power supply, is used for the frequency of the AC current supplied to the excitation coil 82 from the excitation circuit 88.

The elastic support member 83 is a sheet-like member formed of an elastic material such as a silicone rubber and a fluorine rubber, for example. The elastic support member 83 is arranged so as to press the excitation coil 82 against the supporting surface 81a of the support member 81. Thereby, the elastic support member 83 secures the excitation coil 82 in close contact with the supporting surface 81a of the support member 81.

As the material of the magnetic core 84, a ferromagnetic material that is formed of an oxide or alloy material with a high permeability, such as a soft ferrite, a ferrite resin, a non-crystalline alloy (amorphous alloy), permalloy or a temperature-sensitive magnetic alloy is used. The magnetic core 84 functions as a magnetic path unit. The magnetic core 84 induces, to the inside thereof, the magnetic field lines (magnetic flux) of the AC magnetic field generated at the excitation coil 82, and forms a path (magnetic path) of the magnetic field lines in which the magnetic field lines from the magnetic core 84 run across the fixing belt 61 to be directed to the temperature-sensitive magnetic member 64, then pass through the inside of the temperature-sensitive magnetic member 64, and return to the magnetic core 84. Specifically, a configuration in which the AC magnetic field generated at the excitation coil 82 passes through the inside of the magnetic core 84 and the inside of the temperature-sensitive magnetic member 64 is employed, and thereby, a closed magnetic path where the magnetic field lines internally wrap the fixing belt 61 and the excitation coil 82 is formed. Thereby, the magnetic field lines of the AC magnetic field generated at the excitation coil 82 are concentrated at a region of the fixing belt 61, which faces the magnetic core 84.

Here, the material of the magnetic core 84 may be one that has a small amount of loss due to the forming of the magnetic path. Specifically, the magnetic core 84 may be particularly used in a form that reduces the amount of eddy-current loss (shielding or dividing of the electric current path by having a slit or the like, or bundling of thin plates, or the like). In addition, the magnetic core 84 may be particularly formed of a material having a small hysteresis loss.

The length of the magnetic core 84 along the rotation direction of the fixing belt 61 is formed so as to be shorter than the length of the temperature-sensitive magnetic member 64 along the rotation direction of the fixing belt 61. Thereby, the amount of leakage of the magnetic field lines toward the periphery of the IH heater 80 is reduced, resulting in improvement in the power factor. Moreover, the electromagnetic induction toward the metal materials forming the fixing unit 60 is also suppressed and the heat-generating efficiency at the fixing belt 61 (conductive heat-generating layer 612) increases.

<Description of a State in which Fixing Belt Generates Heat>

Next, a description will be given of a state in which the fixing belt 61 generates heat by use of the AC magnetic field generated by the IH heater 80.

Firstly, as described above, the permeability change start temperature of the temperature-sensitive magnetic member 64 is set within a temperature range (140 to 240 degrees C., for example) where the temperature is not less than the fixation setting temperature for fixing color toner images and not greater than the heat-resistant temperature of the fixing belt 61. Then, when the temperature of the fixing belt 61 is not greater than the permeability change start temperature, the temperature of the temperature-sensitive magnetic member 64 near the fixing belt 61 corresponds to the temperature of the fixing belt 61 and then becomes equal to or lower than the permeability change start temperature. For this reason, the temperature-sensitive magnetic member 64 has a ferromagnetic property at this time, and thus, the magnetic field lines H of the AC magnetic field generated by the IH heater 80 form a magnetic path where the magnetic field lines H go through the fixing belt 61 and thereafter, pass through the inside of the temperature-sensitive magnetic member 64 along a spreading direction. Here, the “spreading direction” refers to a direction orthogonal to the thickness direction of the temperature-sensitive magnetic member 64.

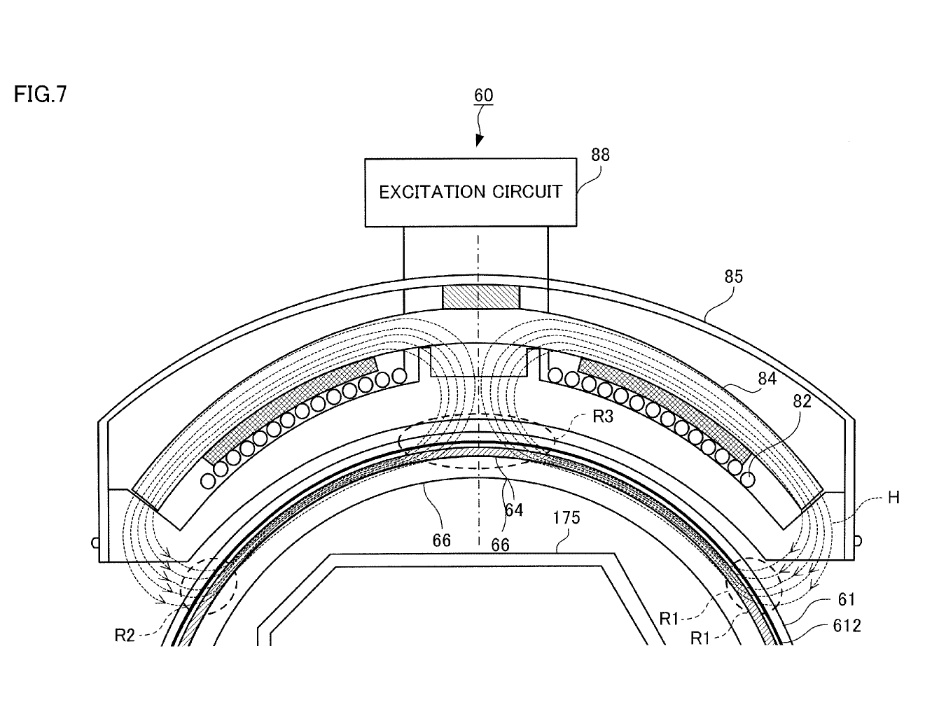

FIG. 7 is a diagram for explaining the state of the magnetic field lines H in a case where the temperature of the fixing belt 61 is within the temperature range not greater than the permeability change start temperature. As shown in FIG. 7, in the case where the temperature of the fixing belt 61 is within the temperature range not greater than the permeability change start temperature, the magnetic field lines H of the AC magnetic field generated by the IH heater 80 form a magnetic path where the magnetic field lines H go through the fixing belt 61, and then pass through the inside of the temperature-sensitive magnetic member 64 in the spreading direction (direction orthogonal to the thickness direction). Accordingly, the number of the magnetic field lines H (density of magnetic flux) per unit area in the region where the magnetic field lines H run across the conductive heat-generating layer 612 of the fixing belt 61 becomes large.

Specifically, after the magnetic field lines H are radiated from the magnetic cores 84 of the IH heater 80 and pass through regions R1 and R2 where the magnetic field lines H run across the conductive heat-generating layer 612 of the fixing belt 61, the magnetic field lines H are induced to the inside of the temperature-sensitive magnetic member 64, which is a ferromagnetic member. For this reason, the magnetic field lines H running across the conductive heat-generating layer 612 of the fixing belt 61 in the thickness direction are concentrated so as to enter the inside of the temperature-sensitive magnetic member 64. Accordingly, the magnetic flux density becomes high in the regions R1 and R2. In addition, in a case where the magnetic field lines H passing through the inside of the temperature-sensitive magnetic member 64 along the spreading direction return to the magnetic core 84, in a region R3 where the magnetic field lines H run across the conductive heat-generating layer 612 in the thickness direction, the magnetic field lines H are generated toward the magnetic core 84 in a concentrated manner from a portion, where the magnetic potential is low, of the temperature-sensitive magnetic member 64. For this reason, the magnetic field lines H running across the conductive heat-generating layer 612 of the fixing belt 61 in the thickness direction move from the temperature-sensitive magnetic member 64 toward the magnetic core 84 in a concentrated manner, so that the magnetic flux density in the region R3 becomes high as well.

In the conductive heat-generating layer 612 of the fixing belt 61 which the magnetic field lines H run across in the thickness direction, the eddy current I proportional to the amount of change in the number of the magnetic field lines H in unit area (magnetic flux density) is generated. Thereby, as shown in FIG. 7, a larger eddy current I is generated in the regions R1, R2 and R3 where a large amount of change in the magnetic flux density occurs. The eddy current I generated in the conductive heat-generating layer 612 generates a Joule heat W (W=I²R), which is multiplication of the specific resistant value R and the square of the eddy current I of the conductive heat-generating layer 612. Accordingly, a large Joule heat W is generated in the conductive heat-generating layer 612 where the larger eddy current I is generated.

As described above, in a case where the temperature of the fixing belt 61 is within the temperature range not greater than the permeability change start temperature, a large amount of heat is generated in the regions R1, R2 and R3 where the magnetic field lines H run across the conductive heat-generating layer 612, and thereby the fixing belt 61 is heated.

Incidentally, in the fixing unit 60 of the present exemplary embodiment, the temperature-sensitive magnetic member 64 is arranged so as to be in contact with the inner circumferential surface of the fixing belt 61, thereby, providing the configuration in which the magnetic core 84 inducing the magnetic field lines H generated at the excitation coil 82 to the inside thereof, and the temperature-sensitive magnetic member 64 inducing the magnetic field lines H running across and going through the fixing belt 61 in the thickness direction are arranged to be close to each other. For this reason, the AC magnetic field generated by the IH heater 80 (excitation coil 82) forms a loop of a short magnetic path, so that the magnetic flux density and the degree of magnetic coupling in the magnetic path increase. Thereby, heat is more efficiently generated in the fixing belt 61 in a case where the temperature of the fixing belt 61 is within the temperature range not greater than the permeability change start temperature.

### <Description of Function for Suppressing Increase in Temperature of Non-Sheet Passing Portion of Fixing Belt>

Next, a description will be given of a function for suppressing an increase in the temperature of a non-sheet passing portion of the fixing belt 61.

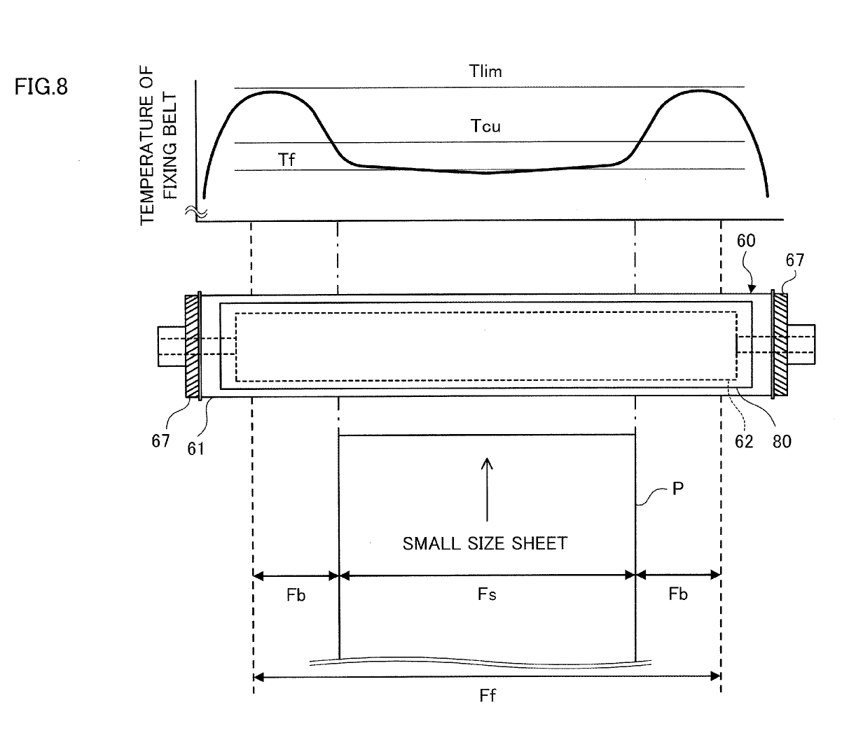

Firstly, a description will be given herein of a case where sheets P of a small size (small size sheets P1) are successively inserted into the fixing unit 60. FIG. 8 is a diagram showing a summary of a temperature distribution in the width direction of the fixing belt 61 when the small size sheets P1 are successively inserted into the fixing unit 60. In FIG. 8, Ff denotes a maximum sheet passing region, which is the width (A3 long side, for example) of the maximum size of a sheet P used in the image forming apparatus 1, Fs denotes a region through which the small size sheet P1 (A4 longitudinal feed, for example) having a smaller horizontal width than that of a maximum size sheet P passes, and Fb denotes a non-sheet passing region through which no small size sheet P1 passes. Note that, sheets are inserted into the image forming apparatus 1 with the center position thereof as the reference point.

As shown in FIG. 8, when the small size sheets P1 are successively inserted into the fixing unit 60, the heat for fixing is consumed at the small size sheet passing region Fs where each of the small size sheets P1 passes. For this reason, the controller 31 (refer to FIG. 1) performs a temperature adjustment control with a fixation setting temperature, so that the temperature of the fixing belt 61 at the small size sheet passing region Fs is maintained within a range near the fixation setting temperature. Meanwhile, at the non-sheet passing regions Fb as well, the same temperature adjustment control as that performed for the small size sheet passing region Fs is performed. However, the heat for fixing is not consumed at the non-sheet passing regions Fb. For this reason, the temperature of the non-sheet passing regions Fb easily increases to a temperature higher than the fixation setting temperature. Then, when the small size sheets P1 are successively inserted into the fixing unit 60 in this state, the temperature of the non-sheet passing regions Fb increases to a temperature higher than the heat-resistant temperature of the elastic layer 613 or the surface release layer 614 of the fixing belt 61, hence damaging the fixing belt 61 in some cases.

In this respect, as described above, in the fixing unit of the present exemplary embodiment, the temperature-sensitive magnetic member 64 is formed of, for example, a Fe—Ni alloy or the like whose permeability change start temperature is set within a temperature range not less than the fixation setting temperature and not greater than the heat-resistant temperature of the elastic layer 613 or the surface release layer 614 of the fixing belt 61. Specifically, as shown in FIG. 8, a permeability change start temperature Tcu of the temperature-sensitive magnetic member 64 is set within a temperature range not less than a fixation setting temperature Tf and not greater than a heat-resistant temperature Tlim of, for example, the elastic layer 613 or the surface release layer 614.

Thus, when the small size sheets P1 are successively inserted into the fixing unit 60, the temperature of the non-sheet passing regions Fb of the fixing belt 61 exceeds the permeability change start temperature of the temperature-sensitive magnetic member 64. Accordingly, the temperature of the temperature-sensitive magnetic member 64 near the fixing belt 61 at the non-sheet passing regions Fb also exceeds the permeability change start temperature in response to the temperature of the fixing belt 61 as in the case of the fixing belt 61. For this reason, the relative permeability of the temperature-sensitive magnetic member 64 at the non-sheet passing regions Fb becomes close to 1, so that the temperature-sensitive magnetic member 64 at the non-sheet passing regions Fb loses the ferromagnetic properties. Since the relative permeability of the temperature-sensitive magnetic member 64 decreases and becomes closer to 1, the magnetic field lines H at the non-sheet passing regions Fb are no longer induced to the inside of the temperature-sensitive magnetic member 64, and start going through the temperature-sensitive magnetic member 64. For this reason, in the fixing belt 61 at the non-sheet passing regions Fb, the magnetic field lines H spread after passing through the conductive heat-generating layer 612, hence leading to a decrease in the density of magnetic flux of the magnetic field lines H running across the conductive heat-generating layer 612. Thereby, the amount of an eddy current I generated at the conductive heat-generating layer 612 decreases, and then, the amount of heat (Joule heat W) generated at the fixing belt 61 decreases. As a result, an excessive increase in the temperature at the non-sheet passing regions Fb is suppressed, and the fixing belt 61 is prevented from being damaged.

As described above, the temperature-sensitive magnetic member 64 functions as a detector that detects the temperature of the fixing belt 61 and also functions as a temperature increase suppresser that suppresses an excessive increase in the temperature of the fixing belt 61 in accordance with the detected temperature of the fixing belt 61, at a time.

The magnetic field lines H passing through the temperature-sensitive magnetic member 64 arrive at the induction member 66 (refer to FIG. 3) and then are induced to the inside thereof. When the magnetic flux arrives at the induction member 66 and then is induced to the inside thereof, a large amount of the eddy current I flows into the induction member 66, into which the eddy current I flows more easily than into the heat conducive layer 612. Thus, the amount of eddy current I flowing into the conductive layer 612 is further suppressed, so that an increase in the temperature at the non-sheet passing regions Fb is suppressed.

At this time, the thickness, material and shape of the induction member 66 are selected in order that the induction member 66 may induce most of the magnetic field lines H from the excitation coil 82, the magnetic field lines H may be prevented from leaking from the fixing unit 60, and heat from the temperature-sensitive magnetic member 64 is sufficiently accumulated. In the present exemplary embodiment, the induction member 66 is formed of Al (aluminum), with a thickness of 1 mm, of a substantially circular arc shape along the temperature-sensitive magnetic member 64. The induction member 66 is arranged so as not to be in contact with the temperature-sensitive magnetic member 64 (average distance therebetween is 4 mm, for example). As another example of the material, Ag or Cu may be particularly used.

Incidentally, when the temperature of the fixing belt 61 at the non-sheet passing regions Fb becomes lower than the permeability change start temperature of the temperature-sensitive magnetic member 64, the temperature of the temperature-sensitive magnetic member 64 at the non-sheet passing regions Fb also becomes lower than the permeability change start temperature thereof. For this reason, the temperature-sensitive magnetic member 64 becomes ferromagnetic again, and the magnetic field lines H are induced to the inside of the temperature-sensitive magnetic member 64. Thus, a large amount of the eddy current I flows into the conductive heat-generating layer 612. For this reason, the fixing belt 61 is again heated.

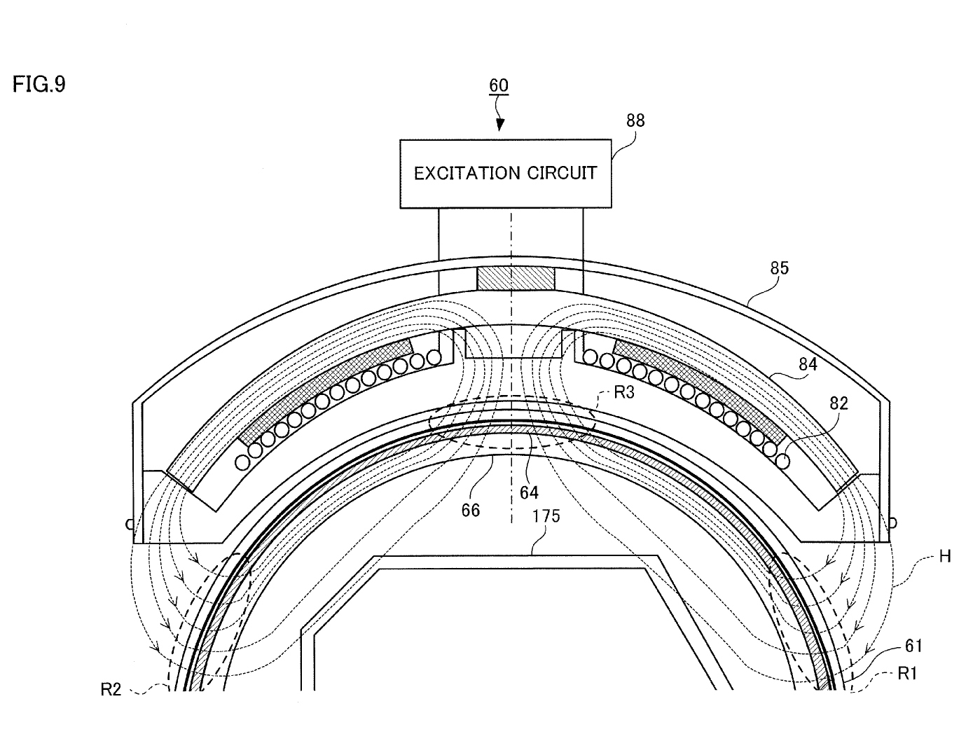

FIG. 9 is a diagram for explaining a state of the magnetic field lines H when the temperature of the fixing belt at the non-sheet passing regions Fb is within the temperature range exceeding the permeability change start temperature. As shown in FIG. 9, when the temperature of the fixing belt 61 at the non-sheet passing regions Fb is within the temperature range exceeding the permeability change start temperature, the relative permeability of the temperature-sensitive magnetic member 64 at the non-sheet passing regions Fb decreases. For this reason, the magnetic field lines H of the AC current generated by the IH heater changes so as to easily go through the temperature-sensitive magnetic member 64. Thereby, the magnetic field lines H of the AC current generated by the IH heater 80 (excitation coil 82) are radiated from the magnetic cores 84 so as to spread toward the fixing belt 61 and arrive at the induction member 66.

Specifically, at the regions R1 and R2 where the magnetic field lines H are radiated from the magnetic cores 84 of the IH heater 80 and then run across the conductive heat-generating layer 612 of the fixing belt 61, since the magnetic field lines H are not easily induced to the temperature-sensitive magnetic member 64, the magnetic field lines H radially spread. Accordingly, the density of the magnetic flux (the number of the magnetic field lines H per unit area) of the magnetic field lines H running across the conductive heat-generating layer 612 of the fixing belt 61 in the thickness direction decreases. In addition, at the region R3 where the magnetic field lines H run across the conductive heat-generating layer 612 in the thickness direction when returning to the magnetic cores 84 again, the magnetic field lines H return to the magnetic cores 84 from the wide region where the magnetic field lines H spread, so that the density of the magnetic flux of the magnetic field lines H running across the conductive heat-generating layer 612 of the fixing belt 61 in the thickness direction decreases.

For this reason, when the temperature of the fixing belt 61 is within the temperature range exceeding the permeability change start temperature, the density of the magnetic flux of the magnetic field lines H running across the conductive heat-generating layer 612 in the thickness direction at the regions R1, R2 and R3 decreases. Accordingly, the amount of the eddy current I generated in the conductive heat-generating layer 612 where the magnetic field lines H run across in the thickness direction decreases, and the Joule heat W generated at the fixing belt 61 decreases. Therefore, the temperature of the fixing belt 61 decreases.

As described above, when the temperature of the fixing belt 61 at the non-sheet passing regions Fb is within a temperature range not less than the permeability change start temperature, the magnetic field lines H are not easily induced to the inside of the temperature-sensitive magnetic member 64 at the non-sheet passing regions Fb. Thus, the magnetic field lines H of the AC magnetic field generated by the excitation coil 82 spread and run across the conductive heat-generating layer 612 of the fixing belt 61 in the thickness direction. Accordingly, the magnetic path of the AC magnetic field generated by the excitation coil 82 forms a long loop, so that the density of magnetic flux in the magnetic path in which the magnetic field lines H pass through the conductive heat-generating layer 612 of the fixing belt 61 decreases.

Thereby, at the non-sheet passing regions Fb where the temperature thereof increases, for example, when the small size sheets P1 are successively inserted into the fixing unit 60, the amount of the eddy current I generated at the conductive heat-generating layer 612 of the fixing belt 61 decreases, and the amount of heat (Joule heat W) generated at the non-sheet passing regions Fb of the fixing belt 61 decreases. As a result, an excessive increase in the temperature of the non-sheet passing regions Fb is suppressed.

### <Description of Temperature-Sensitive Magnetic Property of Temperature-Sensitive Magnetic Member>

In the following, the above-mentioned “temperature-sensitive magnetic property” of the temperature-sensitive magnetic member 64 will be described.

The temperature-sensitive magnetic member 64 of the present exemplary embodiment has such a magnetic property that its permeability (for example, a permeability measured according to JIS C2531) would continue to decrease from when the temperature of the temperature-sensitive magnetic member 64 reaches the above-mentioned “permeability change start temperature” until when the temperature of the temperature-sensitive magnetic member 64 reaches the Curie point (CP), i.e., the temperature above which a material loses its magnetic property. Thus, the magnetic property of the temperature-sensitive magnetic member 64 reversibly changes between the ferromagnetic property and the non-magnetic property (paramagnetic property) in a certain temperature range, and such a magnetic property is called “temperature-sensitive magnetic property.”

The temperature-sensitive magnetic member 64 of the present exemplary embodiment is formed of a material having the above-mentioned characteristics. Specifically, the material has a permeability change start temperature set within a temperature range between the temperature set for the fixing belt 61 to fix a toner image of each color on a sheet (fixation setting temperature) and the heat resistant temperature of the fixing belt 61 (the elastic layer 613 and the surface release layer 614). For this reason, the temperature-sensitive magnetic member 64 has the ferromagnetic property in the fixation setting temperature range. Accordingly, as shown in FIG. 7, the magnetic field lines H of the AC magnetic field generated by the IH heater 80 form a magnetic path in which the magnetic field lines H go through the fixing belt 61 and then pass through the inside of the temperature-sensitive magnetic member 64 in an spreading direction (a direction orthogonal to a thickness direction). This increases the density of the magnetic flux of the magnetic field lines H running across the fixing belt 61 (the regions R1, R2 and R3 in FIG. 7), thereby generating a large amount of heat at the fixing belt 61.

In the temperature range exceeding the permeability change start temperature, on the other hand, the permeability of the temperature-sensitive magnetic member 64 decreases until the temperature of the temperature-sensitive magnetic member 64 reaches the Curie point CP and the relative permeability reaches 1. Accordingly, when the temperature of the non-sheet passing region (for example, the non-sheet passing regions Fb in FIG. 8) of the fixing belt 61 exceeds the fixation setting temperature range, the magnetic property of the region of the temperature-sensitive magnetic member facing the non-sheet passing region change to the non-magnetic property (paramagnetic property). Thus, the density of the magnetic flux of the magnetic field lines H running across the fixing belt 61 (the regions R1, R2 and R3 in FIG. 9) decreases according to the temperature change, thereby generating a smaller amount of heat. Accordingly, an increase in the temperature of the non-sheet passing region of the fixing belt 61 is suppressed.

In this case, to effectively suppress the increase in the temperature of the non-sheet passing region of the fixing belt 61, the temperature-sensitive magnetic member 64 may have such a property that the permeability would steeply decrease toward the Curie point CP in the temperature range exceeding the permeability change start temperature.

Specifically, the temperature increase suppression function of the temperature-sensitive magnetic member 64 at the non-sheet passing region is enhanced if a temperature range in which the magnetic property of the temperature-sensitive magnetic member 64 changes between the ferromagnetic property and the non-magnetic property (paramagnetic property) (“changing range”) is set narrow to some extent, for example, set within about 20 degrees C.

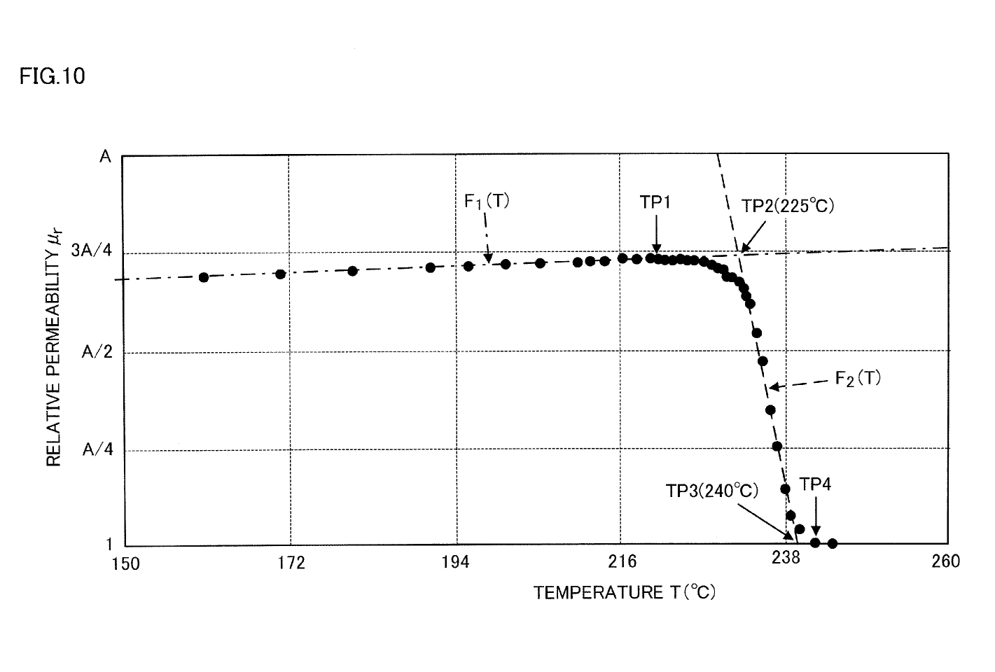

Here, FIG. 10 is a graph showing an example of the temperature characteristics of the relative permeability μᵣ of the temperature-sensitive magnetic member 64 of the exemplary embodiment. As shown in FIG. 10, in a temperature range up to a permeability change start temperature TP1, the relative permeability μᵣ of the temperature-sensitive magnetic member 64 of the present exemplary embodiment has a tendency to gradually increase according to a linear function F₁ (T) as a temperature T of the temperature-sensitive magnetic member 64 increases. When the temperature T of the temperature-sensitive magnetic member 64 exceeds the permeability change start temperature TP1, the relative permeability μᵣ starts to decrease, and thereafter steeply decreases according to a linear function F₂(T) as the temperature T increases. Then, when the temperature T of the temperature-sensitive magnetic member 64 reaches the Curie point CP (TP4), the relative permeability μᵣ of the temperature-sensitive magnetic member 64 becomes 1 (the permeability μ of the temperature-sensitive magnetic member 64=μ₀: μ₀=the permeability of vacuum).

In the present exemplary embodiment, an index temperature TP2 and an index temperature TP3 are defined as indices which quantitatively estimate a changing range in which the magnetic property of the temperature-sensitive magnetic member 64 changes between the ferromagnetic property and the non-magnetic property, in relation to the temperature characteristics of the relative permeability μᵣ of the temperature-sensitive magnetic member 64. As shown in FIG. 10, the index temperature TP2 is an example of the start temperature of the changing range, and corresponds to the temperature at the intersection point between the linear function F₁(T) and the linear function F₂(T). The linear function F₁(T) is an example of a first function indicating the relationship between the temperature T and the relative permeability μᵣ in the temperature range up to the permeability change start temperature TP1, whereas the linear function F₂ (T) is an example of a second function indicating the relationship between the temperature T and the relative permeability μᵣ in a temperature range exceeding the permeability change start temperature TP1.

The index temperature TP3 is an example of the end temperature of the changing range, and corresponds to the temperature at the intersection point between the linear function F₂(T) and the relative permeability μᵣ=1.

As shown in FIG. 10, the temperature range exceeding the permeability change start temperature TP1 includes a region where the relative permeability μᵣ decreases according to a quadratic or higher function. However, the linear function F₂(T), which is an example of the second function, indicates the relationship between the temperature T and the relative permeability μᵣ in a region, where the relative permeability μᵣ decreases according to a linear function, within the temperature range exceeding the permeability change start temperature TP1.

The index temperature TP2 is a temperature at which the magnetic property of the temperature-sensitive magnetic member 64 changes from the ferromagnetic property to the non-magnetic property (paramagnetic property), and may be taken as a temperature at which the temperature-sensitive magnetic member 64 substantially starts to provide the function of suppressing an increase in the temperature of the non-sheet passing region of the fixing belt 61 (function provision starting temperature). That is, even when the temperature of the temperature-sensitive magnetic member 64 exceeds the permeability change start temperature TP1, the decrease amount of the relative permeability μᵣ does not become large until the temperature T reaches a temperature range in which the relative permeability μᵣ decreases according to the linear function F₂(T). Thus, in a temperature range which is not less than the permeability change start temperature TP1 and not greater than the temperature range where the relative permeability μᵣ decreases according to the linear function F₂(T), the temperature-sensitive magnetic member 64 functions with the ferromagnetic property. Thus, the index temperature TP2 may be taken as the function provision starting temperature at which the function of the temperature-sensitive magnetic member 64 is substantially started to be provided.

Meanwhile, in a highest-temperature region of the temperature range where the relative permeability μᵣ decreases in proportion to the temperature T according to the linear function F₂(T), the relative permeability μᵣ of the temperature-sensitive magnetic member 64 becomes almost 1. For this reason, the index temperature TP3 may be taken as a substantial Curie point CP.

Accordingly, a temperature range between the index temperature TP3 and the index temperature TP2 may be defined as the “changing range” in which the magnetic property of the temperature-sensitive magnetic member 64 changes between the ferromagnetic property and the non-magnetic property (paramagnetic property).

The temperature-sensitive magnetic member 64 of the present exemplary embodiment is configured so that the temperature range between the index temperature TP3 and the index temperature TP2 (the temperature difference between the index temperature TP3 and the index temperature TP2), corresponding to the changing range of the magnetic property, would be within about 20 degrees C. With this configuration, the temperature-sensitive magnetic member 64 of the present exemplary embodiment achieves such a magnetic property that the permeability (relative permeability μᵣ) would steeply decrease in the temperature range exceeding the permeability change start temperature. For example, the temperature-sensitive magnetic member 64 illustrated in FIG. 10 is configured to have the index temperature TP2 of 225 degrees C., for example, and the index temperature TP3 of 240 degrees C., for example, thus setting the temperature difference between the index temperature TP3 and the index temperature TP2 to be 15 degrees C., that is, a range within about 20 degrees C.

As described above, by setting the changing range of the magnetic property (the temperature difference between the index temperature TP3 and the index temperature TP2) within about 20 degrees C., the magnetic property of the temperature-sensitive magnetic member 64 at the non-sheet passing regions of the fixing belt 61, changes to the non-magnetic property (paramagnetic property) if the temperature of the non-sheet passing region of the fixing belt 61 changes by more than 20 degrees C. (15 degrees C. in the example shown in FIG. 10) from the index temperature TP2. This enables a reduction in damages caused in the fixing belt 61 having a heat resistant temperature of, for example, approximately 245 degrees C., even if the fixation setting temperature is set high, for example, approximately 160 degrees C. to 180 degrees C.

In other words, it is ideal, in consideration of the function of the temperature-sensitive magnetic member 64, if the temperature difference (the changing range of the magnetic property) between the index temperature TP3 and the index temperature TP2 is zero (0). However, in practice, the material forming the temperature-sensitive magnetic member 64 has the changing range having a certain temperature difference for the magnetic property to change between the ferromagnetic property and the non-magnetic property (paramagnetic property). In the case where the temperature difference of this changing range is large, the magnetic property of the temperature-sensitive magnetic member 64 slowly changes to the non-magnetic property (paramagnetic property) even after the temperature of the fixing belt 61 has increased above the fixation setting temperature. This increases a time required for the temperature of the non-sheet passing region of the fixing belt 61 having increased above the fixation setting temperature to decrease to the fixation setting temperature. Thus, it is difficult to efficiently suppress a temperature increase in the non-sheet passing region. Moreover, for example, in the case of changing the sheet size to a larger one, the speed at which the temperature of the fixing belt 61 increases to the fixation setting temperature also decreases in the region which has been a non-sheet passing region and has then newly become a sheet passing region. This is likely to result in poor fixing.

For these reasons, although it is ideal if the temperature difference of the changing range in which the magnetic property changes between the ferromagnetic property to the non-magnetic property is zero (0), the changing range of the magnetic property of the temperature-sensitive magnetic member 64 (the temperature difference between the index temperature TP3 and the index temperature TP2) is set to have the temperature difference of 20 degrees C. or less which serves as an acceptable range for effectively suppressing an increase in the temperature of the non-sheet passing region of the fixing belt 61.

### <Description of Contact Part of Temperature-Sensitive Magnetic Member and Fixing Belt>

Next, a contact part of the temperature-sensitive magnetic member 64 and the fixing belt 61 will be described.

As described above, the temperature-sensitive magnetic member 64 is formed into an arc shape along the inner circumferential surface of the fixing belt 61, and is arranged to be in contact with the inner circumferential surface of the fixing belt 61. Thereby, heat generated at the temperature-sensitive magnetic member 64 is transferred to the fixing belt 61, thus supplementing the amount of heat generated at the fixing belt 61.

Specifically, even when the temperature of the fixing belt 61 is equal to or lower than the permeability change start temperature and the temperature-sensitive magnetic member 64 thus has the ferromagnetic property, some of the magnetic field lines H from the IH heater 80 run across the temperature-sensitive magnetic member 64 in the thickness direction. Due to such magnetic field lines H, weak eddy currents I occur in the temperature-sensitive magnetic member 64, and hence the temperature-sensitive magnetic member 64 itself also generates heat. Here, the temperature-sensitive magnetic member 64 of the present exemplary embodiment is configured to actively generate heat without being provided with any mechanism, such as a slit, for suppressing the eddy currents I. Moreover, the arc shaped temperature-sensitive magnetic member 64 is arranged so as to have a large area thereof being in contact with the fixing belt 61 having the inner circumferential surface also in a circular arc shape. This configuration allows heat generated at the temperature-sensitive magnetic member 64 to be transferred to the fixing belt 61. Thereby, heat is supplied to the fixing belt 61 from the temperature-sensitive magnetic member 64. In this event, heat is supplied to the fixing belt 61 also from the induction member 66 through the temperature-sensitive magnetic member 64, the induction member 66 arranged to be in contact with the temperature-sensitive magnetic member 64 and storing therein heat from the temperature-sensitive magnetic member 64.

With this configuration, if a temporary drop in the temperature (temperature droop phenomenon) of the fixing belt 61 occurs, for example, at the starting time of the fixing operation, heat is supplementally supplied to the fixing belt from the temperature-sensitive magnetic member 64. Thereby, the degree of drop in the temperature of the fixing belt 61 is reduced, and the temperature of the fixing belt 61 is maintained within a range around the fixation setting temperature.

The temperature-sensitive magnetic member 64, which is a ferromagnetic body when its temperature is not greater than the permeability change start temperature, is arranged so that the IH heater 80 and the fixing belt 61 would be sandwiched between the temperature-sensitive magnetic member 64 and the magnetic core 84, which is also a ferromagnetic body. Thereby, the temperature-sensitive magnetic member 64 of the present exemplary embodiment performs both the function as a magnetic path forming member that forms a magnetic path of the magnetic field lines from the IH heater 80 and the function as a heater that supplies heat to the fixing belt 61. Especially, since the temperature-sensitive magnetic member 64 is configured to cause the fixing belt 61 to slide while being in contact with the fixing belt 61 in order to supply, as a heater, heat to the fixing belt 61, the temperature-sensitive magnetic member 64 needs to have slide stability and slide maintainability with respect to a temperature change from the room temperature to approximately the heat resistant temperature and an axial direction temperature difference occurring in the temperature-sensitive magnetic member 64 when small size sheets are successively fed as will be described later.

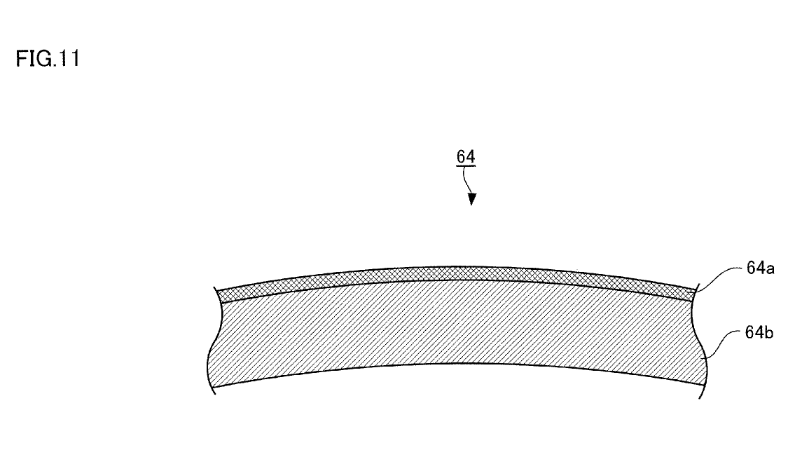

In such a configuration that the temperature-sensitive magnetic member 64 would be arranged to be in contact with the fixing belt 61 to supply heat to the fixing belt 61, a contact surface of the temperature-sensitive magnetic member 64 that is in contact with the fixing belt 61 (an outer circumferential surface in a circular arc shape) is likely to abrade away easily. For this reason, the contact surface, contacting with the fixing belt 61, of the temperature-sensitive magnetic member 64 is covered with an abrasion protection layer that suppresses abrasion. FIG. 11 is a configuration diagram showing a cross sectional layers of the temperature-sensitive magnetic member 64. As shown in FIG. 11, the temperature-sensitive magnetic member 64 is formed of a temperature-sensitive magnetic layer 64a and an abrasion protection layer 64b. The temperature-sensitive magnetic layer 64a is an example of a magnetic layer having the changing range of its magnetic property (the temperature range between the index temperature TP3 and the index temperature TP2) set at 20 degrees C. or less, while the abrasion protection layer 64b is an example of an outer circumferential layer formed as a surface on the fixing belt 61 side. The abrasion protection layer 64b is made of any one of chromium nitride represented by a chemical formula of CrN and chromium nitride represented by a chemical formula of Cr₂N, or a mixture of both. Here, the “mixture” of chromium nitride represented by a chemical formula of CrN and chromium nitride represented by a chemical formula of Cr₂N may be configured of a multilayer including a layer formed of CrN and a layer formed of Cr₂N, or may be configured of a single layer formed by mixing CrN and Cr₂N.

The temperature-sensitive magnetic layer 64a, configured so that the changing range of its magnetic property would be within about 20 degrees C. as shown in FIG. 10, is manufactured by performing heat treatment on a material subjected to rolling processing or press working. In this heat treatment, the material is held, for example, in a hydrogen (H₂) atmosphere maintaining an annealing temperature of 1100 degrees C. or more, for 20 minutes or longer, and is then cooled by 20 degrees C. per minute.

By such a heat treatment, the changing range of the temperature-sensitive magnetic layer 64a is configured to be small, i.e., within about 20 degrees C., consequently increasing the relative permeability μᵣ. Meanwhile, by this heat treatment (annealing), the temperature-sensitive magnetic layer 64a changes to a soft material having hardness (Vickers hardness) of about 120 to about 250 Hv. This is considered to be because crystals of the temperature-sensitive magnetic layer 64a are orientated by the annealing. Thus, the temperature-sensitive magnetic layer 64a becomes a material which abrades away easily by contact with the fixing belt 61.

For this reason, the temperature-sensitive magnetic layer 64a, configured to have the changing range of its magnetic property set within about 20 degrees C., has a substantial need for the abrasion protection layer 64b formed on the outer circumferential surface, on the fixing belt 61 side, of the temperature-sensitive magnetic layer 64a. Here, in general, the abrasion protection layer 64b may have a high Vickers hardness, from the viewpoint of abrasion resistance, and have a low friction coefficient, from the viewpoint of lubricity. For example, diamond-like carbon (DLC) has a high Vickers hardness, i.e., 3000 to 5000 Hv, and a low friction coefficient, i.e., approximately 0.1. Accordingly, it may be particularly used from the viewpoints of abrasion resistance and lubricity.

However, diamond-like carbon is likely to flake off or crack easily if used as the abrasion protection layer 64b of the temperature-sensitive magnetic member 64 of the present exemplary embodiment, configured to have the changing range of its magnetic property set within about 20 degrees C. In general, a material having a high hardness obtains a high compressive residual stress when subjected to physical vapor deposition on the temperature-sensitive magnetic layer 64a or the like. Accordingly, at the interface (adhesive surface) of the temperature-sensitive magnetic layer 64a of the present exemplary embodiment, which is made to be soft by annealing to have a Vickers hardness of about 120 to about 250 Hv, and diamond-like carbon, which is hard with a Vickers hardness of 3000 to 5000 Hv and has a high compression residual stress, the compression residual stress value of the diamond-like carbon is likely to exceed the adhesive strength of the two layers at the interface. For this reason, in some cases, flaking or cracking occurs in the diamond-like carbon, thereby deteriorating slidability. In particular, the temperature-sensitive magnetic member 64, which has its temperature frequently changed between the room temperature (for example, approximately 23 degrees C.) and the temperature at the time of fixing (for example, approximately 200 degrees C.) experiences huge temperature shocks, and is hence likely to have flaking or cracking.

By contrast, the abrasion protection layer 64b, made of any one of chromium nitride represented by a chemical formula of CrN and chromium nitride represented by a chemical formula of Cr₂N, or a mixture of both, is less likely to have flaking or cracking easily when combined with the temperature-sensitive magnetic layer 64a of the present exemplary embodiment. This is considered to be due to the following reason. Chromium nitride represented by a chemical formula of CrN has a Vickers hardness of 1500 to 2200 Hv and chromium nitride represented by a chemical formula of Cr₂N has a Vickers hardness of 1800 to 2500 Hv, and hence both kinds of chromium nitride have Vickers hardness lower than that of diamond-like carbon. Accordingly, the compression residual stress value of chromium nitride is smaller than that of diamond-like carbon, and is hence less likely to exceed the adhesive strength of the two layers at the interface.

In addition, the crystal structure of diamond-like carbon is an amorphous structure including cubic crystals and hexagonal crystals. By contrast, the crystal structure of chromium nitride represented by a chemical formula of CrN includes cubic crystals, and chromium nitride represented by a chemical formula of Cr₂N includes hexagonal crystals. Accordingly, both have crystal structures different from the amorphous structure. Thus, the temperature-sensitive magnetic layer 64a is made of a material such as permalloy, which is alloy of Fe and Ni being cubic crystals, and has its crystals oriented by the annealing. The temperature-sensitive magnetic layer 64a thus formed is considered to have a high affinity with chromium nitride having a crystal structure different from the amorphous structure.

In consideration of the above, the temperature-sensitive magnetic member 64 of the present exemplary embodiment uses any one of chromium nitride represented by a chemical formula of CrN and chromium nitride represented by a chemical formula of Cr₂N, or a mixture of both, as the abrasion protection layer 64b formed on the surface of the temperature-sensitive magnetic layer 64a configured to have the changing range of its magnetic property set within about 20 degrees C. Thereby, the temperature-sensitive magnetic member 64 is configured so that the abrasion protection layer 64b would be less likely to flake off from the temperature-sensitive magnetic layer 64a and cracking would be less likely to occur in the abrasion protection layer 64b. Consequently, in the configuration where the temperature-sensitive magnetic member 64 is arranged to be in contact with the fixing belt 61, the function of the temperature-sensitive magnetic member 64 to supply heat to the fixing belt 61 is stably provided for a long time. Furthermore, the amount of abrasion of the temperature-sensitive magnetic layer 64a is reduced, and consequently the function of the temperature-sensitive magnetic member 64 to suppress an increase in the temperature of the non-sheet passing region of the fixing belt 61 is maintained for a long time.

In an experiment using the present exemplary embodiment, where the total of 150000 small size sheets, specifically, N-Color 104 gsm sheets in B5 size from Fuji Xerox Co., Ltd., are intensively and successively fed, a large temperature difference occurs in an axial direction of the temperature-sensitive magnetic layer 64a (temperature-sensitive magnetic member 64). The temperature difference between the sheet passing region and the non-sheet passing region of the temperature-sensitive magnetic layer 64a at the time of successively feeding the small size sheets is approximately 40 to 50 degrees C. in some cases. In such a case, the non-sheet passing region of the temperature-sensitive magnetic layer 64a reaches 230 to 240 degrees C. It is found out that, even if such a temperature difference occurs, a good condition is maintained for a long time without any flaking of layers even at the interface region.

As described above, in the fixing unit 60 provided in the image forming apparatus 1 of the present exemplary embodiment, the temperature-sensitive magnetic member 64 is arranged to be in contact with the inner circumferential surface of the fixing belt 61. Moreover, the temperature-sensitive magnetic member 64 includes, as the surface on the fixing belt 61 side, the abrasion protection layer 64b made of any one of chromium nitride represented by a chemical formula of CrN and chromium nitride represented by a chemical formula of Cr₂N, or a mixture of both. With this configuration, the function of the temperature-sensitive magnetic member 64 to supply heat to the fixing belt 61 is stably provided for a long time, and the function of the temperature-sensitive magnetic member 64 to suppress an increase in the temperature of the non-sheet passing region of the fixing belt 61 is maintained for a long time.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing member that includes a conductive layer, and fixes toner on a recording medium by heat generation of the conductive layer by electromagnetic induction;
a magnetic field generating member that generates an alternate-current magnetic field intersecting with the conductive layer of the fixing member; and
a magnetic path forming member that has an outer circumferential surface arranged to be in contact with an inner circumferential surface of the fixing member, that forms a magnetic path of the alternate-current magnetic field generated by the magnetic field generating member, and that includes: a magnetic layer configured to have a changing range within a temperature range of about 20 degrees C., the changing range allowing a magnetic property of the magnetic layer to change between a ferromagnetic property and a paramagnetic property in accordance with temperature; and an outer circumferential layer made of any one of or both chromium nitride represented by a chemical formula of CrN and chromium nitride represented by a chemical formula of Cr₂N.

2. The fixing device according to claim 1, wherein the magnetic layer of the magnetic path forming member has Vickers hardness between about 120 Hv and about 250 Hv.

3. The fixing device according to claim 1, further comprising an induction member that is arranged so that an outer circumferential surface of the induction member is in contact with an inner circumferential surface of the magnetic path forming member and that induces the alternate-current electric field generated by the electric field generating member.

4. An image forming apparatus comprising:
a toner image forming unit that forms a toner image;
a transfer unit that transfers the toner image formed by the toner image forming unit onto a recording medium; and
a fixing unit that fixes, to the recording medium, the toner image transferred onto the recording medium,
the fixing unit containing:
a fixing member that includes a conductive layer, and fixes toner on the recording medium by heat generation of the conductive layer by electromagnetic induction;
a magnetic field generating member that generates an alternate-current magnetic field intersecting with the conductive layer of the fixing member; and
a magnetic path forming member that has an outer circumferential surface arranged to be in contact with an inner circumferential surface of the fixing member, that forms a magnetic path of the alternate-current magnetic field generated by the magnetic field generating member, and that includes: a magnetic layer configured to have a changing range within a temperature range of about 20 degrees C., the changing range allowing a magnetic property of the magnetic layer to change between a ferromagnetic property and a paramagnetic property in accordance with temperature; and an outer circumferential layer made of any one of or both chromium nitride represented by a chemical formula of CrN and chromium nitride represented by a chemical formula of Cr₂N.

5. The image forming apparatus according to claim 4, wherein the magnetic layer of the magnetic path forming member of the fixing unit has Vickers hardness between about 120 Hv and about 250 Hv.

6. The image forming apparatus according to claim 4, wherein the fixing unit further comprises an induction member that is arranged so that an outer circumferential surface of the induction member is in contact with an inner circumferential surface of the magnetic path forming member and that induces the alternate-current electric field generated by the electric field generating member.
